(19) United States
(12) Patent Application Publication
(10) Pub. No.: US 2025/0330895 A1
(43) Pub. Date: Oct. 23, 2025

(54) Electronic Devices and Corresponding Methods for Establishing Personal Area Network Communication Channels with Vehicle-Mounted Devices

(71) Applicant: Motorola Mobility LLC, Chicago, IL (US)

(72) Inventors: Michael E. Russell, Lake Zurich, IL (US); Thomas Cohlmia, Chicago, IL (US); Wayne G. Morrison, Lake Zurich, IL (US)

(21) Appl. No.: 18/643,967

(22) Filed: Apr. 23, 2024

(51) Int. Cl. H04W 48/04; G01S 11/04; H04W 48/16; H04W 64/00; H04W 76/10; H04W 76/30

(52) U.S. Cl. CPC H04W 48/04; G01S 11/04; H04W 48/16; H04W 64/003; H04W 76/10; H04W 76/30

(57) ABSTRACT

An electronic device includes a communication device configured for electronic communication with a wireless personal area network associated with a vehicle, an ultra-wideband component electronically communicating with another ultra-wideband component carried by a vehicle-mounted companion electronic device, and one or more processors. The one or more processors determine whether to direct the communication device to establish a paired communication channel with the wireless personal area network associated with the vehicle as a function of a distance between the electronic device and the vehicle-mounted companion electronic device determined from ultra-wideband signals exchanged between the ultra-wideband component and the other ultra-wideband component.

### BACKGROUND

### Technical Field

This disclosure relates generally to electronic devices, and more particularly to electronic devices operable with companion electronic devices.

### Background Art

The technology associated with portable electronic devices such as smartphones and tablet computers is continually improving. New developments in wireless communication technology offer more reliable networks, faster communication speeds, and more bandwidth. Sometimes, the wireless communication technology is so good that connections and data exchanges occur without a user's knowledge, while at other times connections and data exchanges that the user expects to occur fail to occur as expected. It would be advantageous to have improved electronic devices and corresponding methods for establishing wireless communication channels facilitating data exchange between an electronic device and a companion electronic device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more explanatory method steps in accordance with one or more embodiments of the disclosure.

FIG. 2 illustrates one or more other explanatory method steps in accordance with one or more embodiments of the disclosure.

FIG. 3 illustrates one explanatory method in accordance with one or more embodiments of the disclosure.

FIG. 4 illustrates still other explanatory method steps in accordance with one or more embodiments of the disclosure.

FIG. 5 illustrates other explanatory method steps in accordance with one or more embodiments of the disclosure.

FIG. 6 illustrates still other explanatory method steps in accordance with one or more embodiments of the disclosure.

FIG. 7 illustrates one explanatory electronic device in accordance with one or more embodiments of the disclosure.

FIG. 8 illustrates one explanatory companion electronic device in accordance with one or more embodiments of the disclosure.

FIG. 9 illustrates one or more embodiments of the disclosure.

FIG. 10 illustrates a prior art system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, using one or more processors with a ultra-wideband component, whether an electronic device is positioned within, or entering, a driver's seat of a vehicle to which a vehicle-mounted companion electronic device is mounted and, when the communication device of the electronic device is disconnected from a wireless personal area network associated with the vehicle, directing a communication device to establish a paired connection channel with the wireless personal area network associated with the vehicle. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of determining whether to direct a communication device to establish a paired communication channel with a wireless personal area network associated with a vehicle as a function of a distance between the electronic device and a vehicle-mounted companion electronic device determined from ultra-wideband signals exchanged between a ultra-wideband component carried by the electronic device and another ultra-wideband component carried by the vehicle-mounted companion electronic device as described herein. The non-processor circuits may include, but are not limited to, a radio receiver, a radio transmitter, signal drivers, clock circuits, power source circuits, and user input devices. As such, these functions may be interpreted as steps of a method to perform determining, with one or more processors operable with a ultra-wideband component from one or more characteristics associated with ultra-wideband signals that the electronic device is approaching, entering, or in the driver's seat of a vehicle and, where this is the case, establishing an active communication channel with a wireless personal area network provided by electronic components of the vehicle.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

The use of wireless personal area networks, such as Bluetooth.sup.™, has become quite popular. These wireless personal area networks provide wireless communication technologies that allow devices to connect and exchange data over short distances. Using Bluetooth.sup.™ as an illustrative example, this wireless personal area network operates on the 2.4 GHz frequency band and uses radio waves to establish a connection between devices. Bluetooth.sup.™ technology is commonly found in smartphones, tablets, laptops, and various other electronic devices.

To establish a Bluetooth.sup.™ connection, two devices need to go through a process called “pairing.” During pairing, the devices exchange unique identification codes and establish a secure connection. Once paired, the devices can communicate with each other and exchange data, such as files, audio, and control commands.

Bluetooth.sup.™ uses a master-slave architecture, where one device acts as the master and the other as the slave. The master device initiates the connection and controls the communication. The slave device responds to the master's commands and sends data as requested.

Bluetooth.sup.™ technology offers several advantages, including low power consumption, ease of use, and compatibility with a wide range of devices. It has become a standard feature in many consumer electronics, enabling convenient wireless connectivity for various applications.

Embodiments of the disclosure contemplate that while Bluetooth.sup.™ works well in practice, it—and other similar wireless personal area networks—are not problem free. Illustrating by example, consider the situation where a vehicle is equipped with Bluetooth.sup.™ technology such that a user can connect a smartphone to the vehicle to deliver navigation, audio, and other data from the smartphone to the vehicle. When the vehicle only has one driver and is paired with only one smartphone, the Bluetooth.sup.™ connection works well. However, embodiments of the disclosure contemplate that issues arise when there are multiple drivers or multiple paired devices in close proximity to the vehicle.

One common problem occurs when the vehicle connects to the wrong mobile phone. For instance, when the driver starts the vehicle in their garage or driveway, it may connect to a non-driver's phone that happens to be nearby. This can lead to situations where the non-driver's phone starts playing audio or receives calls intended for the driver.

Another issue arises when two drivers in a family leave the residence at the same time. In this scenario, each driver's phone may connect to the incorrect vehicle, causing confusion and inconvenience.

Furthermore, there are cases where the driver does not have the vehicle paired to their mobile phone, but the typical driver is a passenger in a nearby vehicle. When a call is made to or by the passenger, it is routed to the nearby car's audio system, which inadvertently paired with the passenger's device.

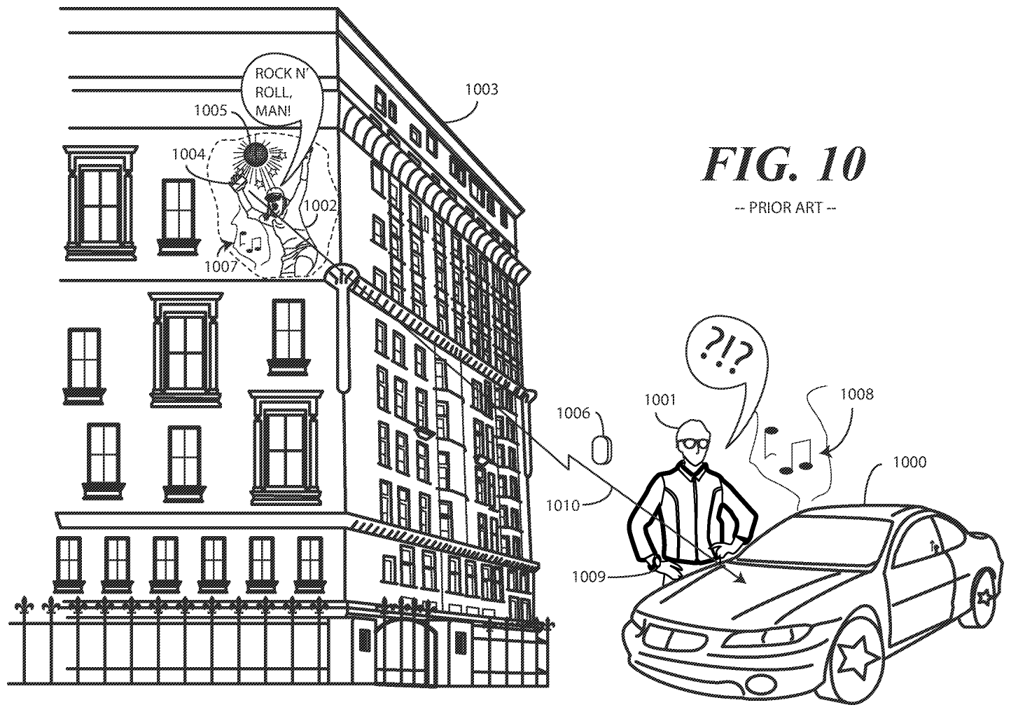

Turning briefly to FIG. 10, illustrated therein is a prior art scenario illustrating how such issues can plague, confuse, and frustrate a person. As shown, a person 1001 is approaching her car 1000, as she is going to drive to grab some of Chuck's Famous Fried Chicken at a nearby Chuck's Famous restaurant. As person 1001 approaches her car, she eagerly anticipates the seamless connection between her electronic device 1009 and the wireless personal area network 1010 in her vehicle. She expects to enjoy her favorite playlist or answer calls hands-free as she embarks on her journey.

However, to her dismay, she discovers that her beatnik roommate 1002 in the adjacent building 1003 is joyfully rocking out and dancing to the captivating tunes 1007 of Buster's Bluesmen. She is rocking so hard that she even has her crazy disco ball 1005 lit up as she screams, “Rock 'n Roll, man!”

Since the beatnik roommate 1002 sometimes borrows the car 1000 and has paired her electronic device 1004 to the wireless personal area network 1010 in the past, her electronic device 1004 has paired itself to the wireless personal area network 1010 and is sending data 1006 representing Buster's current tune, Mac's Chicken Shack Boogie Woogie 1008, which emanates from the car 1000. As shown, this causes the person 1001 frustration and confusion. The person 1001 approaching the car 1000 wonders why her car 1000 is playing music, namely, Mac's Chicken Shack Boogie Woogie 1008, that she did not select and why her calls are not being routed to the wireless personal area network 1010 of the car 1000.

This scenario exemplifies the limitations of prior art wireless personal area network connectivity systems, where accidental connections can occur, leading to disruptions and misunderstandings. The person's expectation of a seamless and personalized in-car experience is shattered as she grapples with the confusion caused by the unintended coupling of her device to the wrong wireless personal area network.

This prior art scene highlights the need for an improved solution that can accurately determine the intended connection and prevent such frustrating and confusing situations. By implementing the proposed solution using ultra-wideband technology, the system can ensure that the correct device is connected to the vehicle's wireless personal area network, providing a seamless and personalized experience for the user.

Moreover, these examples illustrate the need for a solution that can reduce accidental connections and improve the overall Bluetooth.sup.™ connection experience in vehicles with multiple drivers or paired devices. Advantageously, embodiments of the disclosure provide solutions to these problems. Indeed, embodiments of the disclosure use Ultra-Wideband (UWB) technology to determine the user's location and ensure that the device entering from the driver's side is made the primary Bluetooth.sup.™ connection to the vehicle. This solution can be implemented using ultra-wideband technology embedded in smartphones and cars or by using a separate device such as a “FindMe” tag.

By implementing the solutions discussed below, embodiments of the disclosure can accurately determine the user's location and establish the appropriate Bluetooth.sup.™ connection, thereby eliminating the issues caused by accidental connections. Advantageously, embodiments of the disclosure greatly enhance the user experience and provide a more seamless and efficient Bluetooth.sup.™ connectivity system for vehicles with multiple drivers or paired devices.

In one or more embodiments, electronic devices and corresponding methods described herein involves the use of ultra-wideband technology or time-of-flight ranging techniques to determine whether a user is entering from the driver's side or the passenger's side of the vehicle. By accurately identifying the user's location, the electronic devices and corresponding methods can ensure that the device entering from the driver's side is made the primary Bluetooth.sup.™ connection to the vehicle.

The proposed solution can be implemented in vehicles and electronic device such as mobile phones that have ultra-wideband technology embedded in them. However, it can also be used with devices that do not have ultra-wideband technology by utilizing a separate device, such as a “FindMe” Tag. The method involves associating an ultra-wideband transceiver with the vehicle and additional ultra-wideband transceivers with the Bluetooth.sup.™-enabled electronic devices that are paired to the vehicle. Ranging measurements are then made between the vehicle's ultra-wideband transceiver and the transceivers associated with the paired devices.

Based on these ranging measurements, the system determines the position of the device relative to the driver's seat. In one or more embodiments, if the device is on the driver's side and connected, no action is taken. In one or more embodiments, if the device is on the driver's side but disconnected, the system initiates a connection and may send a message to the other device to initiate disconnection if needed.

In one or more embodiments, if the device is on the passenger side and disconnected, no action is taken. In one or more embodiments, if the device is on the passenger side and connected, the system disconnects it and may send a message to the other device to initiate connection if needed.

In one or more embodiments, if the device is outside the vehicle and connected, it is disconnected, and a message may be sent to the other device to initiate connection if needed. In one or more embodiments, if the device is outside the vehicle and disconnected, no action is taken.

Methods described below can be implemented as a software application on the automobile or on one or more mobile phones. When the application is not run on the vehicle, a service running on the phone can check the ultra-wideband retrieved position and initiate a disconnection event when the user is not in the vehicle and in the driver's seat. Optionally, a message can be sent to the other paired device to connect.

The proposed solution offers an intelligent and automated approach to reduce accidental connections and improve the overall Bluetooth.sup.™ connection experience in vehicles with multiple drivers or paired devices. By leveraging ultra-wideband technology, the system ensures that the correct device is connected to the vehicle, eliminating the inconvenience and confusion caused by unintended connections. This solution enhances the user experience and provides a more seamless and efficient Bluetooth.sup.™ connectivity system for vehicles with multiple users.

In one or more embodiments, a method in an electronic device comprises detecting, with one or more processors, a communication device electronically in communication with a vehicle-mounted companion electronic device comprising a first ultra-wideband component. In one or more embodiments, the method comprises determining, by the one or more processors with a second ultra-wideband component carried by the electronic device, whether the electronic device is positioned within, or entering, a driver's seat of a vehicle to which the vehicle-mounted companion electronic device is mounted.

In one or more embodiments, such as when the communication device is disconnected from a wireless personal area network associated with the vehicle and the electronic device is positioned within, or entering, the driver's seat of the vehicle to which the vehicle-mounted companion electronic device is mounted, the method comprises directing, by the one or more processors, the communication device to establish a paired communication channel with the wireless personal area network associated with the vehicle.

As noted above, the methods described herein could be deployed in a user's electronic device, such as a person's smartphone. Alternatively, they can be deployed in a vehicle-mounted companion electronic device, which may be an aftermarket device attached to a vehicle. Illustrating by example, in one or more embodiments an electronic device comprises a communication device configured for electronic communication with a wireless personal area network associated with a vehicle. In one or more embodiments, the electronic device comprises an ultra-wideband component electronically communicating with another ultra-wideband component carried by a vehicle-mounted companion electronic device.

In one or more embodiments, the electronic device comprises one or more processors that are operable with the communication device and the vehicle-mounted companion electronic device. In one or more embodiments, the one or more processors determine whether to direct the communication device to establish a paired communication channel with the wireless personal area network associated with the vehicle as a function of a distance between the electronic device and the vehicle-mounted companion electronic device determined from ultra-wideband signals exchanged between the two ultra-wideband components.

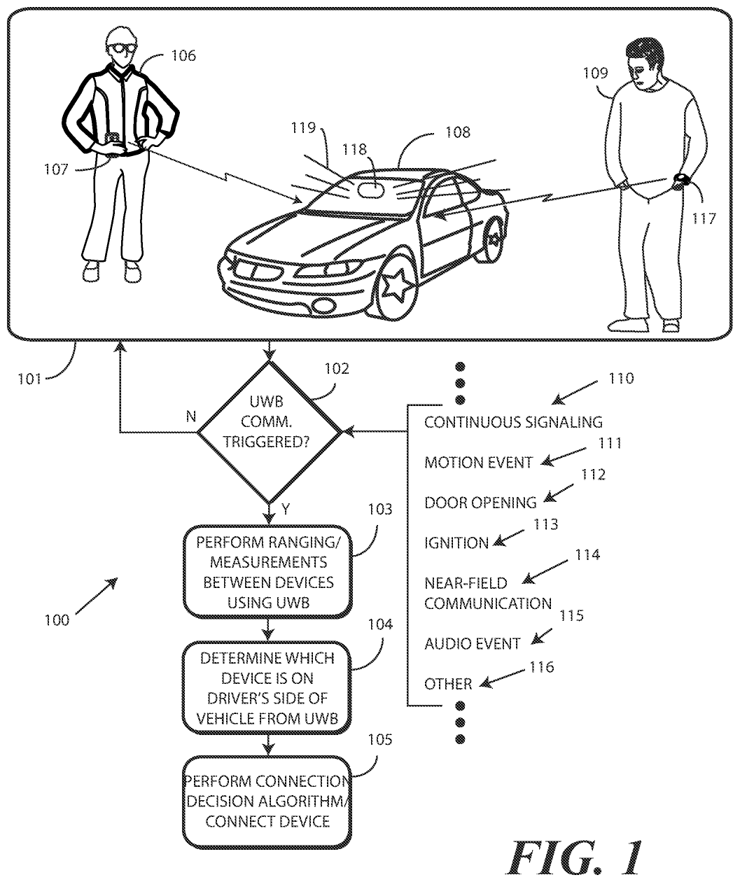

Turning now to FIG. 1, illustrated therein is one explanatory method 100 in accordance with one or more embodiments of the disclosure. As shown at step 101, two people 106,109 are approaching a vehicle 108. The first person 106 has an electronic device 107, which is a smartphone in this example, while the second person 109 also has an electronic device 117, which is shown as a smartwatch.

A vehicle-mounted companion electronic device 118, which is an aftermarket add-on device in this example but could be an integrated OEM component of the vehicle 108 as well, provides a wireless personal area network 119 to which the electronic device 107 belonging to the first person 106 and the other electronic device 117 belonging to the second person 109 can connect. As shown, the first person 106 and the second person 109 are approximately equidistant from vehicle 108.

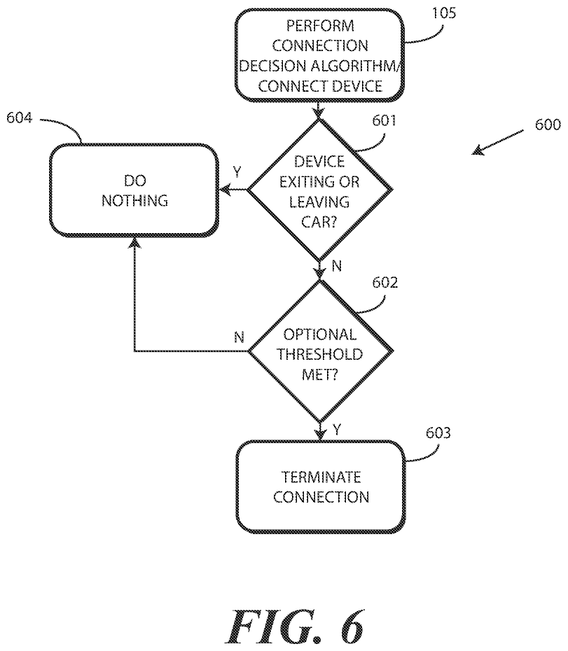

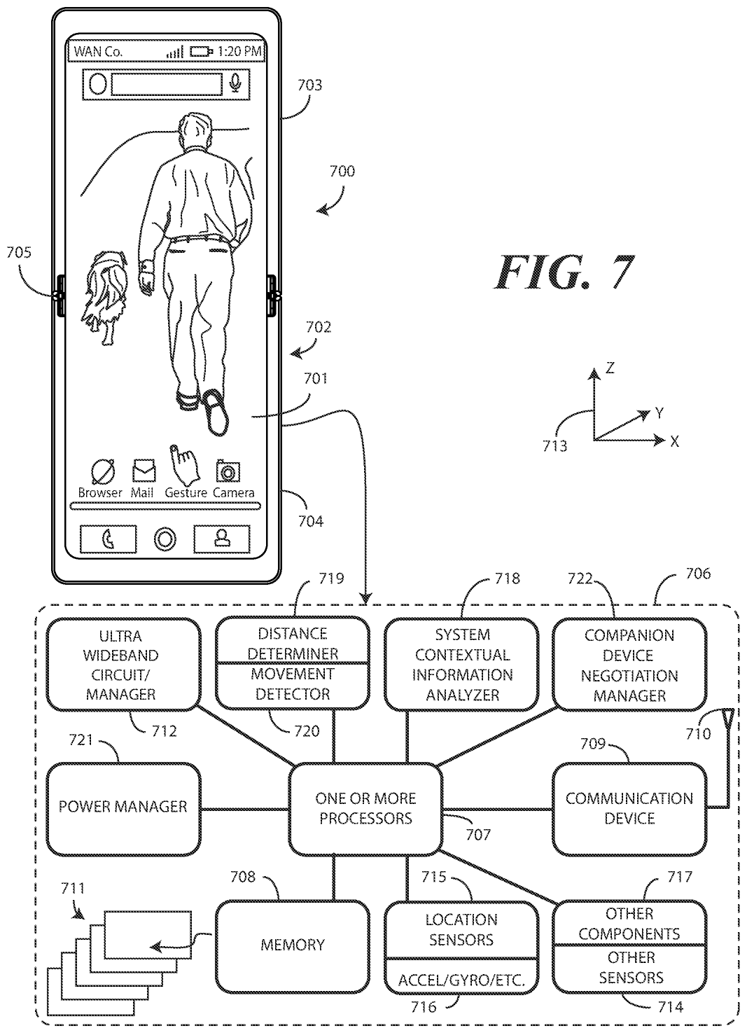

While the vehicle-mounted companion electronic device 118 can be embedded in vehicle 108 as part of the OEM design, in other embodiments it is configured as a self-installed tag that goes in a compartment or on the driver's visor. In step 101 of FIG. 1, the electronic device 107, the other electronic device 117, and the vehicle-mounted companion electronic device 118 are equipped with ultra-wideband components. (While not shown in FIG. 1, such components are shown below with reference to FIGS. 6-7. These ultra-wideband components enable the devices to communicate with each other and determine the distance and location between them.

While the ultra-wideband components used by the first person 106 and the second person 109 are embedded in the electronic devices 107,117 in this example, they could alternatively be a tag the persons 106,109 carry in a bag, place in a pocket, or wear on a wrist or around the neck. In the instances that ultra-wideband component is not part of the original car or smartphone design the method 100 simply requires that the ultra-wideband component be associated with an electronic device 107,117 that has been paired with the vehicle 108 and possibly a training procedure to determine driver side vs. passenger side.

As will be understood by those of ordinary skill in the art having the benefit of this disclosure will understand, ultra-wideband technology utilizes short-range radio waves to transmit data over a wide frequency range. Unlike traditional wireless communication methods, ultra-wideband devices can transmit and receive signals across a broad spectrum of frequencies simultaneously. This allows for precise and accurate distance and location measurements between devices.

When electronic device 107, the other electronic device 117, and the vehicle-mounted companion electronic device 118 are equipped with ultra-wideband components, they can exchange ultra-wideband signals to determine their relative positions. By measuring the time it takes for the ultra-wideband signals to travel between devices and analyzing the signal strength, the devices can calculate the distance therebetween.

Additionally, ultra-wideband devices can utilize techniques such as time-of-flight ranging and angle of arrival (AoA) to further refine the location information. Time-of-flight ranging measures the time it takes for a signal to travel between devices, allowing for precise distance calculations. Angle of arrival determines the angle at which the ultra-wideband signals intersect the receiving device, providing information about the direction and location of the transmitting device.

By leveraging the capabilities of ultra-wideband-equipped devices, the system can accurately determine the distance and location between the electronic device 107, the other electronic device 117, and the vehicle-mounted companion electronic device 118. This information is beneficial for implementing the proposed solution and ensuring that the correct device is connected to the vehicle's wireless personal area network 119, enhancing the overall user experience and eliminating the frustrations caused by unintended connections.

Decision 102 determines whether ultra-wideband communication between the vehicle-mounted companion electronic device 118 and one or both of electronic device 107 and/or electronic device 117 is triggered. At decision 102, ultra-wideband communication can be triggered in various ways, providing flexibility and adaptability to the system. Indeed, FIG. 1 provides several illustrative examples of triggers that can initiate ultra-wideband signaling. These triggers include the receipt of a pairing request via continuous ultra-wideband signaling 110, the detection of motion 111 around the vehicle 108, the opening of a door 112, the ignition of the vehicle's engine 113, the presence of a near-field communication device 114, or the detection of acoustic sounds 115 around the vehicle 108.

For instance, when a pairing request is received, the system can activate ultra-wideband communication to determine the location and proximity of the devices involved in the pairing process. Continuous ultra-wideband signaling 110 can also be employed to maintain an ongoing awareness of the devices in the vicinity, ensuring accurate and up-to-date information for connection decisions.

The detection of motion 111 around the vehicle 108, such as someone approaching or leaving, can serve as a trigger for ultra-wideband communication. This allows the system to dynamically adjust the connection based on the user's presence or absence. Similarly, the opening of a door 112 or the ignition of the vehicle's engine 113 can initiate ultra-wideband signaling to proceed with subsequent steps of the method 100.

In addition, the presence of a near-field communication device 114 or the detection of acoustic sounds 115 around the vehicle can trigger ultra-wideband communication. These triggers provide additional contextual information that can be used to make informed connection decisions.

While the disclosed examples illustrate various triggers for ultra-wideband communication, it is important to note that these are merely illustrative and not exhaustive. Those skilled in the art will having the benefit of this disclosure recognize that other triggers 116 and scenarios can be implemented based on the specific requirements and circumstances of the system. The disclosure provides a foundation for implementing such triggers and encourages those of ordinary skill in the art to explore and adapt the technology to suit their particular needs. Thus, in one or more embodiments decision 102 comprises detecting, with one or more processors of an electronic device 107,117, a communication device of the electronic device 107,117 electronically in communication with the vehicle-mounted companion electronic device 118 comprising a first ultra-wideband component.

At step 103, the method 100 determines, using one or more processors of the electronic devices 107,117 with another ultra-wideband component carried by those electronic devices 107,117, whether one of the electronic devices 107,117 is positioned within, entering, or in a driver's seat of the vehicle 108 to which the vehicle-mounted companion electronic device 118 device is mounted. In one or more embodiments the determination of step 104 occurs via the performance of distance and ranging measurements at step 103. In one or more embodiments, step 103 utilizes the capabilities of ultra-wideband communication to accurately determine the distances between these devices.

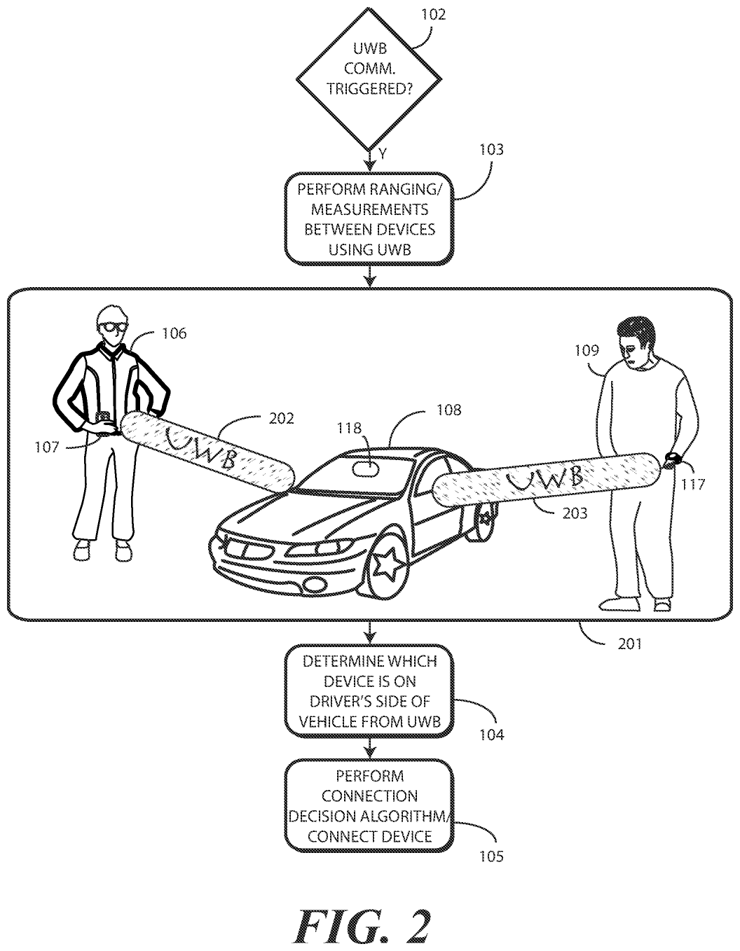

Illustrating by example, turning briefly to FIG. 2 where decision 102 and steps 103,104,105 from FIG. 1 are shown, at step 201 electronic device 107 can exchange ultra-wideband signals 202 with the vehicle-mounted companion electronic device 118. Similarly, electronic device 117 can exchange other ultra-wideband signals 203 with the vehicle-mounted companion electronic device 118.

Turning now back to FIG. 1, as noted above, this ultra-wideband communication works by transmitting ultra-wideband signals (202,203) across a wide range of frequencies simultaneously. These signals are then received by the ultra-wideband components in the devices, allowing for precise measurements of the time it takes for the signals to travel between them. By analyzing the time-of-flight of the signals, the system can calculate the distances between the electronic devices and the vehicle-mounted companion electronic device.

To make these distance measurements, the ultra-wideband components in the devices exchange ultra-wideband signals. These signals contain information about the device's position and are used to calculate the distances based on the time it takes for the signals to travel. The ultra-wideband components can also utilize techniques such as time-of-flight ranging and angle of arrival to further refine the distance measurements.

Time-of-flight ranging measures the time it takes for an ultra-wideband signal to travel between devices. By accurately measuring this time, the system can calculate the distance between the devices with high precision. Angle of arrival, on the other hand, determines the angle at which the ultra-wideband signals intersect the receiving device. This information helps in determining the direction and location of the transmitting device relative to the receiving device.

By leveraging ultra-wideband communication and performing distance or ranging measurements, the system can gather crucial information about the positions of the electronic devices 107,117 and the vehicle-mounted companion electronic device 118. This information allows for making informed connection decisions and ensuring that the correct device is connected to the vehicle's wireless personal area network 119. The precise distance measurements provided by ultra-wideband communication enable the system to accurately determine the proximity of the devices and establish the appropriate connections, enhancing the overall user experience.

Once the determination of which electronic device 107,117 is positioned within, entering, or in the driver's seat of the vehicle 108, when the communication device of that electronic device is disconnected from the wireless personal area network 119 of the vehicle 108 the electronic device is positioned within, entering, or in the driver's seat of the vehicle 108 to which the vehicle-mounted companion electronic device 118 is connected, step 105 comprises directing, by the one or more processors of the electronic device, the communication device to establish a paired communication channel with the wireless personal area network 119 of the vehicle 108.

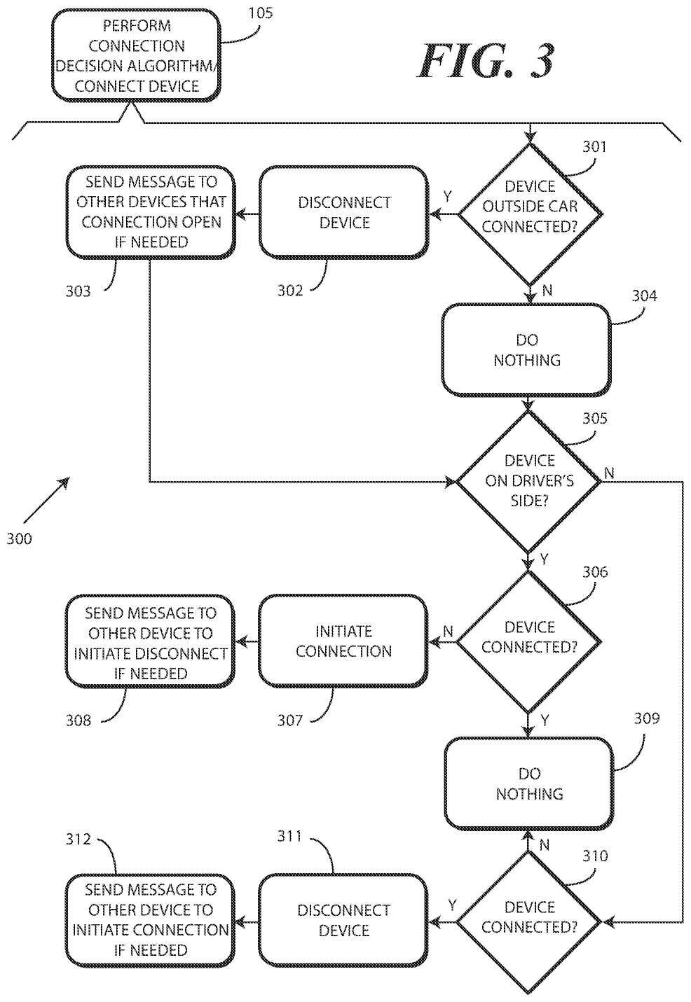

To provide more general applicability, in one or more embodiments a connection decision algorithm can be performed at step 105. Turning now to FIG. 3, illustrated therein is one explanatory of such a connection decision algorithm 300, illustrating how it can be performed in an illustrative example. Other techniques for performing the connection decision algorithm 300 at step 105 will be obvious to those of ordinary skill in the art having the benefit of this disclosure.

At decision 301, the connection decision algorithm 300 determines whether an electronic device situated outside the vehicle (one example would be the beatnik roommate's electronic device (1004) of FIG. 10) currently has a paired communication channel with the wireless personal area network of the vehicle-mounted companion electronic device attached to the vehicle. Where there is no such paired communication channel, the connection decision algorithm 300 moves to step 304 where no action is taken.

By contrast, when there is such a paired communication channel, step 302 can comprise the one or more processors of the electronic device causing a communication device to transmit a disconnect message to the other electronic device actively in communication with the wireless personal area network associated with the vehicle. Optional step 303 can comprise the transmission of a message to the electronic device determined to be positioned within, entering, or in the driver's seat of the vehicle indicating that the wireless personal area network is open such that a new paired communication channel can be established.

Decision 305 is a confirmation decision of step (104) confirming that the selected electronic device is positioned within, entering, or in the driver's seat of the vehicle. If so, step 307 establishes a paired communication channel with the wireless personal area network associated with the vehicle.

As noted above, in one or more embodiments decision 305 comprises measuring, with a ultra-wideband component, a distance between the electronic device and the vehicle-mounted companion electronic device. In one or more embodiments, decision 305 further comprises measuring, with an ultra-wideband component, an angle of arrival at which signals exchanged between the ultra-wideband component carried by the electronic device and the ultra-wideband component carried by the vehicle-mounted companion electronic device intersect the vehicle-mounted companion electronic device. In still other embodiments, decision 305 can comprise measuring, with an ultra-wideband component, an azimuth angle associated with signals exchanged between the ultra-wideband component carried by the electronic device and the other ultra-wideband component carried by the vehicle-mounted companion electronic device. As noted above with reference to FIG. 1, in one or more embodiments decision 305 occurs in response to a trigger event, examples of which include a door of a vehicle to which the vehicle-mounted companion electronic device is mounted opening, a communication device of the electronic device establishing another paired communication channel with another electronic device actively in communication with the wireless personal area network associated with the vehicle, audio signals emanating from the vehicle to which the vehicle-mounted companion electronic device is mounted, and so forth.

Thus, in one or more embodiments decision 305 presents alternative options for determining the position of the electronic device relative to the driver's seat that can be used at step (104) of FIG. 1, with step 105 thereafter establishing a connection with the wireless personal area network associated with the vehicle-mounted companion electronic device. These options can be used individually or in various combinations, depending on the specific implementation and requirements.

In some embodiments, the distance between the electronic device and the vehicle-mounted companion electronic device is measured to make decision 305 using an ultra-wideband component. This distance measurement provides a straightforward way to determine the device's position. By comparing the measured distance to a predefined threshold, the system can determine whether the device is within or entering the driver's seat.

In some other embodiments, decision 305 involves measuring the angle of arrival at which signals exchanged between the ultra-wideband components intersect the vehicle-mounted companion electronic device. This angle measurement adds another dimension to the determination of the device's position. By analyzing the angle of arrival, the system can infer the device's location within the vehicle more accurately.

In still other embodiments, decision 305 comprises utilizing the azimuth angle associated with the signals exchanged between the ultra-wideband components. The azimuth angle provides information about the horizontal direction of the device relative to the vehicle. This measurement can further refine the determination of the device's position and improve the accuracy of establishing the connection. As noted above, distance, angle of arrival, and azimuth angle measurements can be used alone or in combination.

In addition to these methods for determining the device's position and establishing the connection, there are alternative approaches that can be considered. For example, instead of relying solely on ultra-wideband technology, other positioning technologies such as Global Positioning System (GPS) or Radio Frequency Identification (RFID) could be used in combination or as alternatives. These technologies may offer different advantages in terms of accuracy, cost, or power consumption.

Additionally, the triggering events discussed above, such as door opening or ignition, can be expanded to include other context-aware triggers. For instance, the system could detect the presence of the user's wearable device or use voice recognition to identify the driver. These alternative triggers can enhance the overall user experience and provide more flexibility in establishing the connection.

By exploring different combinations of positioning technologies and expanding the triggering events, the design of decision 305 can adapt to various scenarios and user preferences. This flexibility allows for a more personalized and seamless connection experience, ensuring that the electronic device is always connected to the wireless personal area network in the most efficient and convenient way possible.

Where decision 305 determines that an electronic device is positioned within, entering, or in the driver's seat of a vehicle, decision 306 determines whether that electronic device is already connected to the wireless personal area network of the vehicle-mounted companion electronic device. Where it is, step 309 takes no action since the proper electronic device has established a paired communication channel with the wireless personal area network of the vehicle-mounted companion electronic device.

Otherwise, step 307 initiates establishment of the paired communication channel with the wireless personal area network of the vehicle-mounted companion electronic device. Optional step 308 can comprise transmitting a disconnect message to another electronic device actively in communication with the wireless personal area network associated with the vehicle.

Where decision 305 determines that a detected electronic device is not positioned within, entering, or in the driver's seat of the vehicle, decision 310 determines whether that electronic device, which does not belong to the driver, has a paired communication channel with the wireless personal area network of the vehicle-mounted companion electronic device. If it does not, step 309 takes no action. Otherwise, step 311 disconnects the paired communication channel with the wireless personal area network of the vehicle-mounted companion electronic device. Optional step 312 can then comprise the transmission of a message to the electronic device determined to be positioned within, entering, or in the driver's seat of the vehicle indicating that the wireless personal area network is open such that a new paired communication channel can be established.

Thus, as illustrated and described with reference to FIG. 3, in one or more embodiments step 105 can comprise a connection decision algorithm 300 that begins by associating an ultra-wideband transceiver with the vehicle and additional ultra-wideband transceivers with the Bluetooth-enabled electronic devices such as smartphones that are paired to the vehicle. These transceivers enable the devices to exchange ultra-wideband signals and facilitate ranging measurements.

In response to a trigger event, such as the opening of a door, ignition, or a Bluetooth.sup.™ connection request, the connection decision algorithm 300 initiates ranging measurements between the vehicle's ultra-wideband transceiver and the transceivers associated with the paired devices. These measurements provide information about the distance and location of the devices relative to the vehicle.

The ranging measurements are then compared against the driver's seat position. If a device is on the driver's side and connected, as determined by decisions 305,306, no action is taken at step 309. If a device is on the driver's side but disconnected, as determined by decisions 305,306, the system initiates a connection at step 307 and may send a message to the other device to initiate disconnection, if necessary, at step 308. If a device is on the passenger side and disconnected, as determined by decisions 305,310, no action is taken at step 309. However, if a device is on the passenger side and connected, as determined by decisions 305,310, the system disconnects it at step 311, and may send a message to the other device to initiate connection if needed at step 312.

Furthermore, if a device is outside the vehicle and connected, as determined by decision 301, it is disconnected at step 302. A message may be sent to the other device to initiate connection, if necessary, at step 303. Conversely, if a device is outside the vehicle and disconnected, as determined by decision 301, no action is taken at step 304.

The connection decision algorithm 300 used in conjunction with step 105 can be implemented as a software application on the automobile or on one or more mobile phones. When the application is not run on the vehicle, a service running on the phone can check the ultra-wideband retrieved position and initiate a disconnection event when the user is not in the vehicle and in the driver's seat. Optionally, a message can be sent to the other paired device to connect.

This connection decision algorithm 300 provides an intelligent and automated solution to reduce accidental connections and improve the overall Bluetooth.sup.™ connection experience in vehicles with multiple drivers or paired devices. By leveraging ultra-wideband technology and implementing the proposed steps 302,303,304,307,308,309,311,312 and decisions 301,305,306,310, step 105 ensures that the correct device is connected to the vehicle, eliminating the frustrations and inconveniences caused by unintended connections. This method enhances the user experience and provides a seamless and efficient Bluetooth.sup.™ connectivity system for vehicles with multiple users.

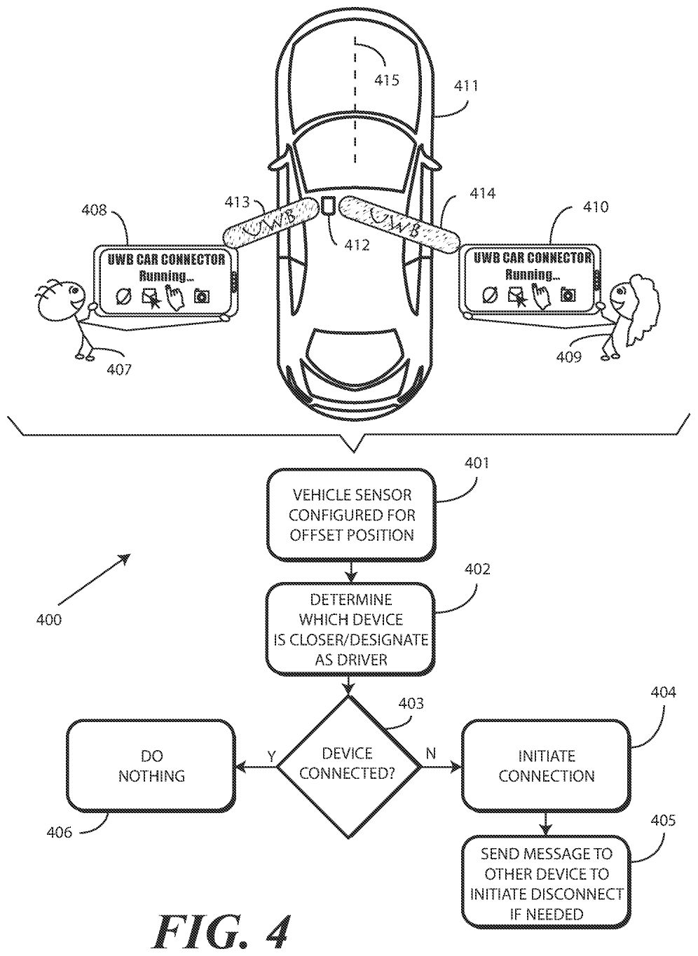

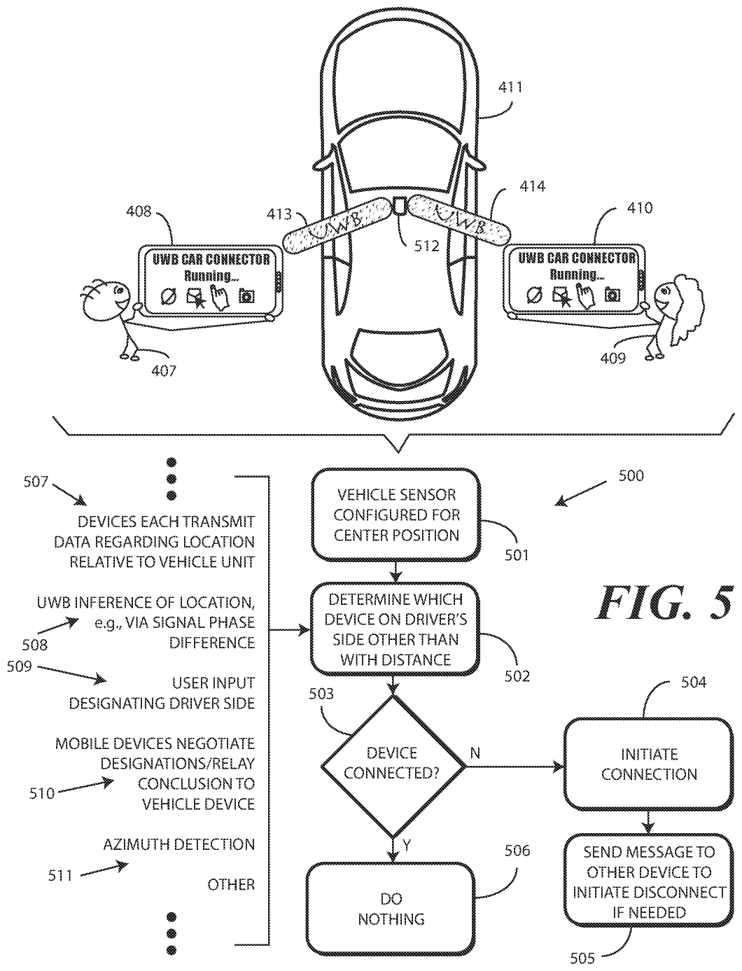

Embodiments of the disclosure contemplate that the vehicle-mounted companion electronic device can be mounted in different locations. Referring now to FIGS. 4 and 5, illustrated therein are two distinct configurations of the ultra-wideband device integration within the vehicle environment.

FIG. 4 depicts an embodiment where the vehicle-mounted companion electronic device 412 is positioned with an offset within the vehicle 411, showcasing the flexibility of installation locations such as a compartment or the driver's visor. This arrangement is particularly useful when the ultra-wideband device is not embedded as part of the original equipment manufacturer design but is instead a self-installed tag. In contrast, FIG. 5 illustrates a centrally mounted vehicle-mounted companion electronic device 512, which may be indicative of an original equipment manufacturer design where the ultra-wideband device is seamlessly integrated into the vehicle's architecture.

As noted above, while FIGS. 4-5 illustrate the ultra-wideband component of user 407 and user 409 being carried by smartphones 408,410, in other embodiments the personal ultra-wideband component associated with user 407 and user 409, which interacts with the vehicle-mounted counterpart, can be incorporated into various personal items, such as a tag within a bag, a tag within a pocket, or even a wearable companion electronic device. For scenarios where ultra-wideband technology is not originally included in the car or smartphone design, the system simply necessitates that the ultra-wideband device be linked with the smartphones 408,410 that are paired with the vehicle 411. Additionally, a training procedure may be employed to discern between the driver's side and passenger's side positioning, ensuring accurate functionality.

Beginning with FIG. 4, at step 401 the vehicle-mounted companion electronic device 412 is configured with an offset position as shown in vehicle 411. Said differently, at step 401 the vehicle-mounted companion electronic device 412 is coupled to the vehicle 411 at an off-center location relative to a medial delineation 415 of the vehicle 411. As shown, a first user 407 carrying a first smartphone 408 approaches the vehicle 411 from a first side, namely, the driver's side, while a second user 409 approaches the vehicle 411 from a second side, which is the passenger's side in this illustrative example.

At step 402, the system determines which smartphone 408,410 is positioned within, entering, or in the driver's seat. In one or more embodiments, step 402 comprises receiving, with an ultra-wideband component carried by a device coupled to a vehicle, namely, vehicle-mounted companion electronic device 412, at least two ultra-wideband signals 413,414 from at least two electronic devices, namely, smartphone 408 and smartphone 410, approaching, entering, or in the vehicle 411.

In one or more embodiments, perhaps in accordance with the connection decision algorithm (300) of FIG. 3, step 402 comprises determining, with one or more processors operable with the ultra-wideband component from one or more characteristics associated with the at least two ultra-wideband signals 413,414 which smartphone 408 is approaching, entering, or in a driver's seat of the vehicle. In one or more embodiments, the one or more characteristics associated with the at least two ultra-wideband signals 413,414 determine which smartphone 408,410 is closer to the vehicle-mounted companion electronic device 412. In this illustrative example, the method 400 determines that smartphone 408 is approaching the driver's seat, while smartphone 410 is approaching the passenger's seat.

Decision 403 then determines if smartphone 408 has established a paired communication channel with the wireless personal area network provided by the vehicle-mounted companion electronic device 412. If it has, step 406 takes no action. Otherwise, step 404 directs the communication device of smartphone 408 to establish a paired communication channel with the wireless personal area network associated with the vehicle-mounted companion electronic device 412. In this illustration, this occurs as a function of the location of the smartphone 408 relative to the driver's seat of the vehicle 411, and more particularly, as a function of a distance between the smartphone 408 and the vehicle-mounted companion electronic device 412 determined from the ultra-wideband signals 413,414 exchanged between the smartphones 408,410 and the vehicle-mounted companion electronic device 412.

If smartphone 410 has already established a paired communication channel with the wireless personal area network provided by the vehicle-mounted companion electronic device 412, optional step 405 can comprise asking smartphone 410 to disconnect that paired communication channel. Illustrating by example, in one or more embodiments step 406 can comprise directing, by the one or more processors of smartphone 408 using the ultra-wideband component, for smartphone 410 to terminate another active communication channel with the wireless personal area network provided by the vehicle-mounted companion electronic device 412.

By contrast, FIG. 5 presents a more complicated scenario where the vehicle-mounted companion electronic device 512 is centrally mounted within the vehicle 411 at step 501. As before, a first user 407 carrying a first smartphone 408 approaches the vehicle 411 from a first side, namely, the driver's side, while a second user 409 approaches the vehicle 411 from a second side, which is the passenger's side in this illustrative example.

Decision 503 then determines whether the communication device of each smartphone 408,410 should establish a paired communication channel with the wireless personal area network associated with the vehicle-mounted companion electronic device 512 as a function of the distance between the smartphones 408,410 and the vehicle-mounted companion electronic device 512. In one or more embodiments, this comprises the exchange of ultra-wideband signals 413,414 as previously described.

Since step 502 determines the distances to be the same, or nearly the same, the method 500 of FIG. 5 utilizes additional intelligence that was not required in the method (400) of FIG. 4 to properly connect the proper smartphone 408,410 to the vehicle-mounted companion electronic device 512. In particular, step 502 determines which smartphone 408,410 is positioned within, entering, or in the driver's seat of the vehicle 411 using indicia other than distance.

These indicia can take various forms. In one or more embodiments, step 502 comprises each smartphone 408,410 transmitting its location 507 to the vehicle-mounted companion electronic device 512. Those of ordinary skill in the art having the benefit of this disclosure will recognize that smartphones 408,410 can determine location through various methods and technologies.

Illustrating by example, one common approach is to utilize Global Positioning System (GPS) technology, which relies on a network of satellites to provide accurate location information. By receiving signals from multiple satellites, the smartphones 408,410 can triangulate position and determine latitude and longitude coordinates. This enables the smartphones 408,410 to provide precise locations to the vehicle-mounted companion electronic device 512.

Additionally, smartphones 408,410 can also utilize other positioning technologies such as Wi-Fi positioning, cellular network positioning, and sensor-based positioning (e.g., using accelerometers and gyroscopes) to further enhance location accuracy. These technologies work together to ensure that the smartphones 408,410 can accurately determine its location in various environments and provide the vehicle-mounted companion electronic device 512 with valuable location-based information.

In other embodiments, step 502 comprises the vehicle-mounted companion electronic device 512 inferring location 508 using signal phase differences. In one or more embodiments, the smartphones 408,410 can use signal phase differences to infer its location 508 through a technique called phase-based ranging. This method relies on measuring the phase difference between signals received from multiple sources, such as Wi-Fi access points or Bluetooth.sup.™ beacons. By analyzing the phase differences, either the vehicle-mounted companion electronic device 512 or smartphones 408,410 in communication with the vehicle-mounted companion electronic device 512 can estimate the distance between itself and each signal source. This information is then used to triangulate the smartphone's position. Signal phase-based ranging can provide accurate location estimates, especially in indoor environments (such as garages for the vehicle 411) where GPS signals may be weak or unavailable.

In still other embodiments, user input 509 can identify which smartphone 408,410 is positioned within, entering, or in the driver's seat. Illustrating by example, a user 407,409 can simply actuate a user actuation target on the display of their smartphone 408,410 to designate themselves as the driver in a simple system. Similarly, the smartphones 408,410 can perform negotiations 510 using contextual information to determine which smartphone 408,410 “wins” the driver designation. Azimuth detection 511 relative to the vehicle-mounted companion electronic device 512 can be used as well. These techniques are illustrative only, as other non-distance measurement techniques that can be used at step 502 will be obvious to those of ordinary skill in the art having the benefit of this disclosure.

Since smartphone 408 is again positioned within, entering, or in the driver's seat of the vehicle 411, decision 503 then determines if smartphone 408 has established a paired communication channel with the wireless personal area network provided by the vehicle-mounted companion electronic device 512. If it has, step 506 takes no action.

Otherwise, step 504 directs the communication device of smartphone 408 to establish a paired communication channel with the wireless personal area network associated with the vehicle-mounted companion electronic device 512. In this illustration, this occurs as a function of the location of the smartphone 408 relative to the driver's seat of the vehicle 411.

If smartphone 410 has already established a paired communication channel with the wireless personal area network provided by the vehicle-mounted companion electronic device 412, optional step 505 can comprise asking smartphone 410 to disconnect that paired communication channel. Illustrating by example, in one or more embodiments step 506 can comprise directing, by the one or more processors of smartphone 408 using the ultra-wideband component, for smartphone 410 to terminate another active communication channel with the wireless personal area network provided by the vehicle-mounted companion electronic device 412.

Turning now to FIG. 6, illustrated therein is another explanatory method 600 in accordance with one or more embodiments of the disclosure. Just as the methods (400,500) of FIGS. 4 and 5, as well as the method (100) of FIG. 1, can be used to establish a paired communication channel with a wireless personal area network of a vehicle-mounted companion electronic device when an electronic device is positioned within, entering, or in a driver's seat of a vehicle, embodiments of the disclosure also allow for the termination of this paired communication channel with the wireless personal area network when the electronic device exits the vehicle. The method 600 of FIG. 6 illustrates how this can happen.

Beginning at step 105, a paired communication channel with a wireless personal area network provided by a vehicle-mounted companion electronic device is established as previously described. Decision 601 then comprised determining, using an ultra-wideband component, whether an electronic device in communication with the wireless personal area network is outside, or is exiting, the driver's seat of the vehicle to which the vehicle-mounted companion electronic device is mounted.

Optional decision 602, which can be omitted in some embodiments, expands the determination of whether the electronic device is exiting or outside of the vehicle using distance-based measurements. Illustrating by example, decision 602 determines whether the electronic device in communication with the wireless personal area network when a distance between the vehicle-mounted companion electronic device and the electronic device expands beyond a predefined distance, one example of which is the width of the vehicle. In other embodiments, the predefined distance is defined by a distance that extends from the vehicle-mounted companion electronic device to a boundary of the vehicle. Other examples of such predefined distances suitable for causing a termination of the paired communication channel with the wireless personal area network will be obvious to those of ordinary skill in the art having the benefit of this disclosure.

Where the electronic device is determined to be outside or exiting the driver's seat of the vehicle, optionally by at least a predefined distance, step 603 comprises directing the communication device of the electronic device to terminate the paired communication channel with the wireless personal area network of the vehicle-mounted companion electronic device. Otherwise, the paired communication channel can continue at step 604.

Now that basic methods have been described, a deeper look into the hardware of one explanatory electronic device and one explanatory vehicle-mounted companion electronic device will be provided. Beginning with the electronic device, and turning now to FIG. 7, illustrated therein is one explanatory electronic device 700 configured in accordance with one or more embodiments of the disclosure.

The electronic device 700 of FIG. 7 is a portable electronic device and is shown as a smartphone for illustrative purposes. However, it should be obvious to those of ordinary skill in the art having the benefit of this disclosure that other electronic devices may be substituted for the explanatory smart phone of FIG. 7. For example, the electronic device 700 could equally be a conventional desktop computer, palm-top computer, a tablet computer, a gaming device, a media player, or other device.

This illustrative electronic device 700 includes a display 701, which may optionally be touch-sensitive. Users can deliver user input to the display 701, which serves as a user interface for the electronic device 700. In one embodiment, users can deliver user input to the display 701 of such an embodiment by delivering touch input from a finger, stylus, or other objects disposed proximately with the display 701. In one embodiment, the display 701 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 700 of FIG. 7 also includes a device housing 702. In one embodiment, the device housing 702 includes two housing members, namely, a first device housing 703 that is coupled to a second device housing 704 by a hinge 705 such that the first device housing 703 is pivotable about the hinge 705 relative to the second device housing 704 between a closed position and an axially displaced open position. In other embodiments, such as that associated with the smartphones (408,410) of FIGS. 4-5, the device housing 702 will be rigid and will include no hinge.

In still other embodiments, the device housing 702 will be manufactured from a flexible material such that it can be bent and deformed. Where the device housing 702 is manufactured from a flexible material or where the device housing 702 includes a hinge, the display 701 can be manufactured on a flexible substrate such that it bends. In one or more embodiments, the display 701 is configured as a flexible display that is coupled to the first device housing 703 and the second device housing 704, spanning the hinge 705. Features can be incorporated into the device housing 702, including control devices, connectors, and so forth.

Also shown in FIG. 7 is an explanatory block diagram schematic 706 of the explanatory electronic device 700. In one or more embodiments, the block diagram schematic 706 is configured as a printed circuit board assembly disposed within the device housing 702 of the electronic device 700. Various components can be electrically coupled together by conductors, or a bus disposed along one or more printed circuit boards.

The illustrative block diagram schematic 706 of FIG. 7 includes many different components. Embodiments of the disclosure contemplate that the number and arrangement of such components can change depending on the particular application. Accordingly, electronic devices configured in accordance with embodiments of the disclosure can include some components that are not shown in FIG. 7, and other components that are shown may not be needed and can therefore be omitted.

In one embodiment, the electronic device includes one or more processors 707. In one embodiment, the one or more processors 707 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 706. Each of the application processor and the auxiliary processor(s) can be configured to process and execute executable software code to perform the various functions of the electronic device with which the block diagram schematic 706 operates. A storage device, such as memory 708, can optionally store the executable software code used by the one or more processors 707 during operation.

In this illustrative embodiment, the block diagram schematic 706 also includes a communication device 709 that can be configured for wired or wireless communication with one or more other devices or networks. The networks can include a wide area network, a local area network, and/or personal area network. The communication device 709 may also utilize wireless technology for communication, such as, but are not limited to, peer-to-peer or ad hoc communications such as HomeRF, Bluetooth and IEEE 802.11, and other forms of wireless communication such as infrared technology. The communication device 709 can include wireless communication circuitry, one of a receiver, a transmitter, or transceiver, and one or more antennas 710.

In one embodiment, the one or more processors 707 can be responsible for performing the primary functions of the electronic device with which the block diagram schematic 706 is operational. For example, in one embodiment the one or more processors 707 comprise one or more circuits operable with the display 701 to present presentation information to a user. The executable software code used by the one or more processors 707 can be configured as one or more modules 211 that are operable with the one or more processors 707. Such modules 711 can store instructions, control algorithms, and so forth.

In one or more embodiments, the block diagram schematic 706 includes an ultra-wideband component 712. In one or more embodiments, the ultra-wideband component is similar to the communication device 709 in that it is configured to perform wireless communications with one or more other ultra-wideband components that may be integrated into, or attached to, other devices. The illustrative ultra-wideband component of FIG. 7 is a dedicated ultra-wideband transceiver constructed into the electronic device 700 configured to use the one or more antennas 710 or its own antenna structure to communicate, using ultra-wideband technology, with another ultra-wideband component. In one or more embodiments, the ultra-wideband component comprises wireless communication circuitry, one of a receiver, a transmitter, or transceiver, and one or more antennas, which may be separate from, or the same as, the one or more antennas 710 used by the communication device 709.

The inclusion of an ultra-wideband component 712 advantageously allows wireless communication with another ultra-wideband component connected to or integrated into another electronic device that is fast and secure, all while requiring very little power. In one or more embodiments, the ultra-wideband component 712 consumes at least an order of magnitude less energy than does the communication device 709.

Ultra-wideband communication is especially well suited to embodiments of the disclosure because it is configured for short-range (within 250 meters) communication, which is well beyond the typical distance from a vehicle-mounted companion electronic device that will occur when an electronic device such as the electronic device 700 of FIG. 7 is situated somewhere near the driver's seat of the vehicle to which the vehicle-mounted companion electronic device is mounted.

Additionally, the accuracy of location, and therefore the accuracy of distance measurements, is within a centimeter or less. This is in contrast to Bluetooth.sup.™ which has an accuracy range of between one and five meters, and is far better than Wi-Fi, which has an accuracy of five to fifteen meters. Ultra-wideband is also quite reliable, in that it offers strong immunity to multi-path communication channels and interference in the line of sight. It also offers exceptional bandwidth, with data communications occurring at up to 27 Mbps, which is in contrast to the 2 Mbps provided by Bluetooth.sup.™. Ultra-wideband is also very low latency, with typical latencies being less than a millisecond, which is in contrast to the several seconds of latency that can occur with Bluetooth.sup.™.

In one or more embodiments, the ultra-wideband component 712 can also be used to measure angle of arrival. Effectively, when the one or more antennas 710 are configured as an antenna array, the ultra-wideband component 712 can compare signals received from one side of the antenna array with other signals received from another side of the antenna array to determine an orientation of the electronic device 700 in three-dimensional space 713 relative to a vehicle-mounted companion electronic device having another ultra-wideband component attached thereto or integrated therein.

Thus, angle of arrival measures the phase difference between two receive antennas of an antenna array to determine the amount of relative angle offset between the antenna array and a source of the signals. If two devices are situated normally to each other, then the angle of arrival would be either zero or very small. Additionally, this angle of arrival is independent of distance. The angle of arrival measurement is capable of measuring where the electronic device 700 is in relation to another electronic device from which phase differentiated signals are received in terms of elevation and azimuth as well.

To illustrate the independence of distance, if the electronic device 700 is situated normal to another electronic device with an angle of arrival that is zero, this angle of arrival remains zero when the electronic device 700 moves toward, or away from, the other electronic device (without rotating and staying on the same trajectory). It should be noted that an angle of arrival measurement can also measure how parallel the plane of the electronic device 700 and the ultra-wideband antenna array of the other electronic device are arranged (when on bore sight for the two antennas). Again, a zero angle of arrival would mean the two antenna arrays are perfectly parallel and perpendicular to each other. Again, in most situations the angle of arrival is relatively independent of distance.

Various sensors 714 can be operable with one or more processors 707. One example of a sensor that can be included with the various sensors 714 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 707, to detect an object in close proximity with—or touching—the surface of the display 701 or the device housing 702 of the electronic device 700 by establishing electric field lines between pairs of capacitive sensors and then detecting perturbations of those field lines.

Another example of a sensor that can be included with the various sensors 714 is a geo-locator that serves as a location detector 715. In one embodiment, location detector 715 is able to determine location data. Location can be determined by capturing the location data from a constellation of one or more earth orbiting satellites, or from a network of terrestrial base stations to determine an approximate location. The location detector 715 may also be able to determine location by locating or triangulating terrestrial base stations of a traditional cellular network, or from other local area networks, such as Wi-Fi networks.

Another example of a sensor that can be included with the various sensors 714 is an orientation detector 716 operable to determine an orientation and/or movement of the electronic device 700 in three-dimensional space 713. Illustrating by example, the orientation detector 716 can include an accelerometer, gyroscopes, or other device to detect device orientation and/or motion of the electronic device 700. Using an accelerometer as an example, an accelerometer can be included to detect motion of the electronic device. Additionally, the accelerometer can be used to sense some of the gestures of the user, such as one talking with their hands, running, or walking.

The orientation detector 716 can determine the spatial orientation of an electronic device 700 in three-dimensional space 713 by, for example, detecting a gravitational direction. In addition to, or instead of, an accelerometer, an electronic compass can be included to detect the spatial orientation of the electronic device 700 relative to the earth's magnetic field. Similarly, one or more gyroscopes can be included to detect rotational orientation of the electronic device 700.

Other components 717 operable with one or more processors 707 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 717 can also include proximity sensors. The proximity sensors fall in to one of two camps: active proximity sensors and “passive” proximity sensors. Either the proximity detector components or the proximity sensor components can be generally used for gesture control and other user interface protocols.

The other components 717 can optionally include a barometer operable to sense changes in air pressure due to elevation changes or differing pressures of the electronic device 700. The other components 717 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 700. Similarly, a temperature sensor can be configured to monitor temperature about an electronic device.

A context engine 718 can then be operable with the various sensors to detect, infer, capture, and otherwise determine persons and actions that are occurring in an environment about the electronic device 700. For example, where included one embodiment of the context engine 718 determines assessed contexts and frameworks using adjustable algorithms of context assessment employing information, data, and events. These assessments may be learned through repetitive data analysis. Alternatively, a user may employ a menu or user controls via the display 701 to enter various parameters, constructs, rules, and/or paradigms that instruct or otherwise guide the context engine 718 in detecting multi-modal social cues, emotional states, moods, and other contextual information. The context engine 718 can comprise an artificial neural network or other similar technology in one or more embodiments.

In one or more embodiments, the context engine 718 is operable with the one or more processors 707. In some embodiments, the one or more processors 707 can control the context engine 718. In other embodiments, the context engine 718 can operate independently, delivering information gleaned from detecting multi-modal social cues, emotional states, moods, and other contextual information to the one or more processors 707. The context engine 718 can receive data from the various sensors 714. In one or more embodiments, the one or more processors 707 are configured to perform the operations of the context engine 718.

In one or more embodiments, the electronic device 700 includes a distance determination manager 719 that is operable with the ultra-wideband component 712 to determine a precise distance (within one centimeter) of the electronic device 700 in relation to other electronic devices also having ultra-wideband components or ultra-wideband tags (the difference between a ultra-wideband component and a ultra-wideband tag is that the ultra-wideband component is integrated into an electronic device as an original component, while a ultra-wideband tag is a self-contained ultra-wideband component that can be attached to an electronic device as a retrofit item to configure a legacy electronic device to communicate via ultra-wideband technology).

A motion detector 720 determines when the electronic device 700 moves. In one or more embodiments, the one or more processors 707 of the electronic device 700 dynamically update the vehicle-mounted companion electronic device and/or other electronic devices within an environment of the electronic device 700 as a function of the distance (determined by the distance determination manager 719) between the electronic device 700 and the vehicle-mounted companion electronic device.

While ultra-wideband communication is very conservative with respect to power consumption, embodiments of the disclosure contemplate that the electronic device 700 can be even more efficient when such distance updates only occur when the distance between the electronic device 700 and the vehicle-mounted companion electronic device has changed. Accordingly, in one or more embodiments distance notifications are sent, altered, or adjusted in response to one or both of the distance determination manager 719 detecting a change in the distance between the electronic device 700 and the vehicle-mounted companion electronic device and/or the motion detector 720 determining that the electronic device 700 has moved relative to the vehicle-mounted companion electronic device. To that end, a power manager 721 can be configured to ensure that distance measurements, ultra-wideband communications, user interface enhancements, and other operations are only performed once the electronic device 700 has moved since the last similar operation was performed.

A vehicle-mounted companion electronic device integration manager 722 is operable to determine whether to direct the communication device 709 to establish a paired communication channel with a wireless personal area network associated with a vehicle or vehicle-mounted companion electronic device attached to a vehicle as a function of a distance between the electronic device 700 and the vehicle or vehicle-mounted companion electronic device determined from one or both of the distance determination manager 719 and/or signals received by the ultra-wideband component 712. In some embodiments, the vehicle-mounted companion electronic device integration manager 722 is operable to determine whether to direct the communication device 709 to establish the paired communication channel with the wireless personal area network associated with the vehicle and/or vehicle-mounted companion electronic device as a function of a location of the electronic device 700, optionally determined by the location detector 715, relative to a driver's seat of the vehicle.

In one or more embodiments, the vehicle-mounted companion electronic device integration manager 722 directs the communication device 709 to later terminate the paired communication channel with the wireless personal area network associated with the vehicle and/or the vehicle-mounted companion electronic device when a distance between the electronic device 700 and vehicle or vehicle-mounted companion electronic device expands beyond a predefined distance. The method (600) of FIG. 6 illustrates one technique for accomplishing this termination. As noted above, in one or more embodiments the predefined distance is defined by a distance extending from the vehicle-mounted companion electronic device to a perimeter or other boundary of the vehicle. Other predefined distances will be obvious to those of ordinary skill in the art having the benefit of this disclosure.

The vehicle-mounted companion electronic device integration manager 722 can be configured to perform other operations as well. Illustrating by example, in one or more embodiments the vehicle-mounted companion electronic device integration manager 722 can cause the communication device 709 to deliver a paired communication channel disconnect message to another electronic device in communication with a wireless personal area network associated with a vehicle or vehicle-mounted companion electronic device prior to directing the communication device 709 to establish a paired communication channel with the wireless personal area network.

In one or more embodiments, the vehicle-mounted companion electronic device integration manager 722 allows the one or more processors 707 of the electronic device 700 to connect to a vehicle-mounted companion electronic device. The vehicle-mounted companion electronic device integration manager 722 can optionally facilitates wireless streaming of content to a larger display of a vehicle-mounted companion electronic device, such as when the vehicle-mounted companion electronic device is an original equipment manufacturer device integrated into a vehicle. In one or more embodiments, neither a cable nor a docking station is required for the vehicle-mounted companion electronic device integration manager 722 to redirect content to another device. Instead, the vehicle-mounted companion electronic device integration manager 722 employs the communication device 709 and the one or more antennas 710 to transmit content to a vehicle-mounted companion electronic device.

The inclusion of the vehicle-mounted companion electronic device integration manager 722 allows the electronic device 700 to automatically connect to a wireless personal area network associated with a vehicle when the electronic device 700 is positioned within, entering, or in the driver's seat of the vehicle. The vehicle-mounted companion electronic device integration manager 722 can optionally be used for other tasks, such as presenting pictures, videos, television shows, or movies on the larger display of a vehicle-mounted companion electronic device. Additionally, the vehicle-mounted companion electronic device integration manager 722 can facilitate gaming, video conferences, and other content presentation tasks using the display of a vehicle-mounted companion electronic device as well.

In one or more embodiments, motion detectors 720 carried by the electronic device 700 can determine when the electronic device 700 moves relative to the vehicle-mounted companion electronic device. When this occurs, the context engine 718, functioning as a distance determination manager, can repeat the distance determination, with the vehicle-mounted companion electronic device integration manager 722 thereafter again determine whether the electronic device 700 is still positioned within, entering, or in the driver's seat.

In one or more embodiments, the ultra-wideband component 712 can also perform an ultra-wideband angle of arrival measurement to determine an orientation of the electronic device 700 in three-dimensional space 713 relative to the vehicle-mounted companion electronic device. Illustrating by example, the ultra-wideband angle of arrival measurement can be used to determine whether a person holding an electronic device 700 is facing the vehicle-mounted companion electronic device or is facing away from the vehicle-mounted companion electronic device. In one or more embodiments, the vehicle-mounted companion electronic device integration manager 722 can cause the communication device 709 to establish a paired communication channel with the wireless personal area network of the vehicle-mounted companion electronic device when the electronic device 700 is oriented and moving toward the vehicle-mounted companion electronic device, while causing the vehicle-mounted companion electronic device to terminate the paired communication channel when the electronic device 700 is oriented and moving away from the vehicle-mounted companion electronic device.

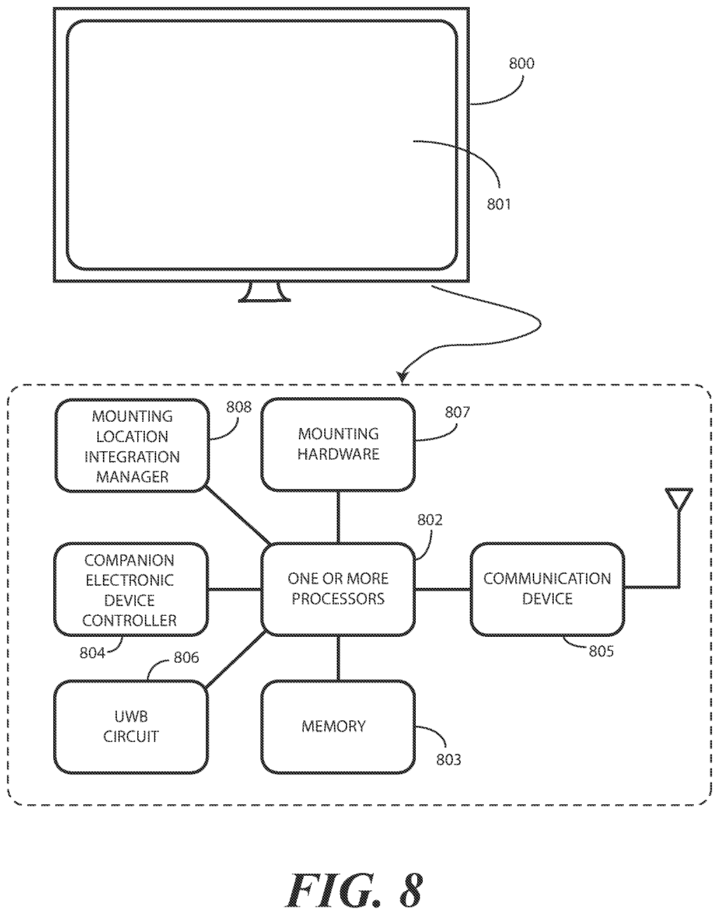

Turning now to FIG. 8, illustrated therein is one explanatory vehicle-mounted companion electronic device 800 in accordance with one or more embodiments of the disclosure. In this illustrative embodiment, the vehicle-mounted companion electronic device 800 comprises a mounting attachment 807 with which it can be attached to a vehicle. In other embodiments, the vehicle-mounted companion electronic device 800 can take other forms.

Illustrating by example, the vehicle-mounted companion electronic device 800 can be integrated into a vehicle's electronic system. Alternatively, a person may configure a computer, a tablet computer, or an ultra-wideband tag to operate as the vehicle-mounted companion electronic device 800. Other examples of vehicle-mounted companion electronic devices 800 will be obvious to those of ordinary skill in the art having the benefit of this disclosure. Regardless of configuration, in one or more embodiments the vehicle-mounted companion electronic device 800 includes one or more processors 802, a display 801, a memory 803, a companion electronic device controller 804, and a communication device 805 capable of wired or wireless communication with an electronic device such as the electronic device (700) of FIG. 7.

In one or more embodiments, when coupled by a wireless connection to such an electronic device (700), the vehicle-mounted companion electronic device 800 can direct and instruct which electronic device should couple to a wireless personal area network of the vehicle or with the vehicle-mounted companion electronic device 800 itself. In one or more embodiments, the companion electronic device controller 804 can use its ultra-wideband component 806 and knowledge of mounting location stored in the mounting location integration manager 808 to receive at least two ultra-wideband signals from at least two electronic devices approaching, entering, or in the vehicle. The companion electronic device controller 804 can determine, from the ultra-wideband signals, which electronic device of the at least two electronic devices is approaching, entering, or in the driver's seat of the vehicle, and can direct the communication device of that electronic device to establish an active communication channel with a wireless personal area network provided by electronic components of the vehicle.

The companion electronic device controller 804 can also direct another electronic device of the at least two electronic devices to terminate another active communication channel with the wireless personal area network so that the electronic device entering the driver's seat can establish the same. In one or more embodiments, when the vehicle-mounted companion electronic device 800 is mounted at an off-center location relative to a medial delineation of the vehicle, this information can be stored in the mounting location integration manager 808.

In one or more embodiments, the vehicle-mounted companion electronic device 800 includes an ultra-wideband component 806 that can communicate with the ultra-wideband component of another electronic device. In one or more embodiments, the ultra-wideband component 806 is an ultra-wideband communication device that is integrated into the vehicle-mounted companion electronic device 800. In other embodiments, the ultra-wideband component 806 is configured as a “tag” that includes one of a transmitter and receiver or transceiver and one or more antennas. When communicating with another ultra-wideband component, the ultra-wideband component 806 can be either a responder or an initiator of communication. In one or more embodiments, the ultra-wideband component 806 of the vehicle-mounted companion electronic device 800 is capable of functioning in a similar manner to the ultra-wideband component (712) of the electronic device (700) of FIG. 7.

It is to be understood that in both FIG. 7 and FIG. 8, the elements illustrated are provided for illustrative purposes only in accordance with embodiments of the disclosure. Neither is intended to be a complete schematic diagram of the various components required. Therefore, other electronic devices in accordance with embodiments of the disclosure may include various other components obvious to those of ordinary skill in the art having the benefit of this disclosure, but not shown in FIG. 7 or FIG. 8, or may include a combination of two or more components or a division of a particular component into two or more separate components, and still be within the scope of the present disclosure.

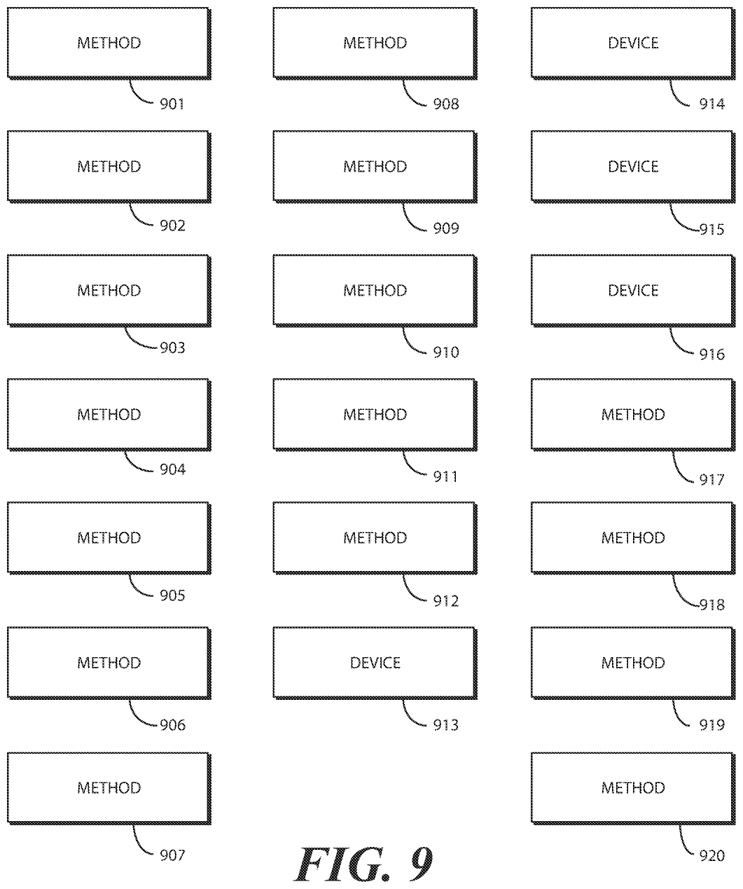

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises detecting, with one or more processors, a communication device electronically in communication with a vehicle-mounted companion electronic device comprising a first ultra-wideband component. At 901, the method comprises determining, by the one or more processors with a second ultra-wideband component carried by the electronic device, whether the electronic device is positioned within, or entering, a driver's seat of a vehicle to which the vehicle-mounted companion electronic device is mounted. At 901, when the communication device is disconnected from a wireless personal area network associated with the vehicle and the electronic device is positioned within, or entering, the driver's seat of the vehicle to which the vehicle-mounted companion electronic device is mounted, the method comprises directing, by the one or more processors, the communication device to establish a paired communication channel with the wireless personal area network associated with the vehicle.

At 902, the method of 901 further comprises causing, by the one or more processors, the communication device to transmit a disconnect message to another electronic device actively in communication with the wireless personal area network associated with the vehicle. At 903, the determining of 901 comprises measuring, with the second ultra-wideband component, a distance between the electronic device and the vehicle-mounted companion electronic device.

At 904 the determining of 903 further comprises measuring, with the second ultra-wideband component, an angle of arrival at which signals exchanged between the first ultra-wideband component and the second ultra-wideband component intersect the vehicle-mounted companion electronic device. At 905, the determining of 903 further comprises measuring, with the second ultra-wideband component, an azimuth angle associated with signals exchanged between the first ultra-wideband component and the second ultra-wideband component.

At 906, the determining of 901 occurs in response to a trigger event detected by one or more sensors of the electronic device. At 907, the trigger event of 906 comprises a door of the vehicle to which the vehicle-mounted companion electronic device is mounted opening.

At 908, the trigger event of 906 comprises ignition of an engine of the vehicle to which the vehicle-mounted companion electronic device is mounted. At 909, the trigger event of 906 comprises the communication device establishing another paired communication channel with another electronic device actively in communication with the wireless personal area network associated with the vehicle. At 910, the trigger event of 906 comprises audio signals emanating from the vehicle to which the vehicle-mounted companion electronic device is mounted.

At 911, the method of 901 further comprises determining, by the one or more processors with the second ultra-wide component carried by the electronic device, whether the electronic device is outside, or exiting, the driver's seat of the vehicle to which the vehicle-mounted companion electronic device is mounted. At 911, when the communication device is connected to the wireless personal area network associated with the vehicle, the method of 901 further comprises directing, by the one or more processors, the communication device to terminate the paired communication channel with the wireless personal area network associated with the vehicle.

At 912, an electronic device comprises a communication device configured for electronic communication with a wireless personal area network associated with a vehicle. At 912, the electronic device comprises an ultra-wideband component electronically communicating with another ultra-wideband component carried by a vehicle-mounted companion electronic device.

At 912, the electronic device comprises one or more processors operable with the communication device and the ultra-wideband component. At 912, the one or more processors determine whether to direct the communication device to establish a paired communication channel with the wireless personal area network associated with the vehicle as a function of a distance between the electronic device and the vehicle-mounted companion electronic device determined from ultra-wideband signals exchanged between the ultra-wideband component and the other ultra-wideband component.

At 913, the one or more processors of 912 further determine whether to direct the communication device to establish the paired communication channel with the wireless personal area network associated with the vehicle as a function of a location of the electronic device relative to a driver's seat of the vehicle. At 914, the one or more processors of 912 direct the communication device to terminate the paired communication channel with the wireless personal area network associated with the vehicle when the distance expands beyond a predefined distance.

At 915, the predefined distance of 914 is defined by another distance extending from the vehicle-mounted companion electronic device and a boundary of the vehicle. At 916, the one or more processors of 912 cause the communication device to deliver a paired communication channel disconnect message to another electronic device in communication with the wireless personal area network associated with the vehicle prior to directing the communication device to establish a paired communication channel with the wireless personal area network associated with the vehicle.

At 917, a method comprises receiving, with an ultra-wideband component carried by a device coupled to a vehicle, at least two ultra-wideband signals from at least two electronic devices approaching, entering, or in the vehicle. At 917, the method comprises determining, with one or more processors operable with the ultra-wideband component from one or more characteristics associated with the at least two ultra-wideband signals which electronic device of the at least two electronic devices are approaching, entering, or in a driver's seat of the vehicle. At 917, the method comprises directing, by the one or more processors using the ultra-wideband component, the which of the at least two electronic devices is approaching, entering, or in the driver's seat of the vehicle to establish an active communication channel with a wireless personal area network provided by electronic components of the vehicle.

At 918, the method of 917 further comprises also directing, by the one or more processors using the ultra-wideband component, another electronic device of the at least two electronic devices to terminate another active communication channel with the wireless personal area network provided by the electronic components of the vehicle. At 918, the device of 917 is coupled to the vehicle at an off-center location relative to a medial delineation of the vehicle. At 920, the one or more characteristics of 919 associated with the at least two ultra-wideband signals determine which electronic device of the at least two electronic devices is closer to the device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, with one or more processors, a communication device electronically in communication with a vehicle-mounted companion electronic device comprising a first ultra-wideband component;
determining, by the one or more processors with a second ultra-wideband component carried by the electronic device, whether the electronic device is positioned within, or entering, a driver's seat of a vehicle to which the vehicle-mounted companion electronic device is mounted; and
when the communication device is disconnected from a wireless personal area network associated with the vehicle and the electronic device is positioned within, or entering, the driver's seat of the vehicle to which the vehicle-mounted companion electronic device is mounted, directing, by the one or more processors, the communication device to establish a paired communication channel with the wireless personal area network associated with the vehicle.

2. The method of claim 1, further comprising causing, by the one or more processors, the communication device to transmit a disconnect message to another electronic device actively in communication with the wireless personal area network associated with the vehicle.

3. The method of claim 1, wherein the determining comprises measuring, with the second ultra-wideband component, a distance between the electronic device and the vehicle-mounted companion electronic device.

4. The method of claim 3, wherein the determining further comprises measuring, with the second ultra-wideband component, an angle of arrival at which signals exchanged between the first ultra-wideband component and the second ultra-wideband component intersect the vehicle-mounted companion electronic device.

5. The method of claim 3, wherein the determining further comprises measuring, with the second ultra-wideband component, an azimuth angle associated with signals exchanged between the first ultra-wideband component and the second ultra-wideband component.

6. The method of claim 1, wherein the determining occurs in response to a trigger event detected by one or more sensors of the electronic device.

7. The method of claim 6, wherein the trigger event comprises a door of the vehicle to which the vehicle-mounted companion electronic device is mounted opening.

8. The method of claim 6, wherein the trigger event comprises ignition of an engine of the vehicle to which the vehicle-mounted companion electronic device is mounted.

9. The method of claim 6, wherein the trigger event comprises the communication device establishing another paired communication channel with another electronic device actively in communication with the wireless personal area network associated with the vehicle.

10. The method of claim 6, wherein the trigger event comprises audio signals emanating from the vehicle to which the vehicle-mounted companion electronic device is mounted.

11. The method of claim 1, further comprising:
determining, by the one or more processors with the second ultra-wide component carried by the electronic device, whether the electronic device is outside, or exiting, the driver's seat of the vehicle to which the vehicle-mounted companion electronic device is mounted; and
when the communication device is connected to the wireless personal area network associated with the vehicle, directing, by the one or more processors, the communication device to terminate the paired communication channel with the wireless personal area network associated with the vehicle.

12. An electronic device, comprising:
a communication device configured for electronic communication with a wireless personal area network associated with a vehicle;
an ultra-wideband component electronically communicating with another ultra-wideband component carried by a vehicle-mounted companion electronic device; and
one or more processors operable with the communication device and the ultra-wideband component, wherein the one or more processors determine whether to direct the communication device to establish a paired communication channel with the wireless personal area network associated with the vehicle as a function of a distance between the electronic device and the vehicle-mounted companion electronic device determined from ultra-wideband signals exchanged between the ultra-wideband component and the another ultra-wideband component.

13. The electronic device of claim 12, wherein the one or more processors further determine whether to direct the communication device to establish the paired communication channel with the wireless personal area network associated with the vehicle as a function of a location of the electronic device relative to a driver's seat of the vehicle.

14. The electronic device of claim 12, wherein the one or more processors direct the communication device to terminate the paired communication channel with the wireless personal area network associated with the vehicle when the distance expands beyond a predefined distance.

15. The electronic device of claim 14, wherein the predefined distance is defined by another distance extending from the vehicle-mounted companion electronic device and a boundary of the vehicle.

16. The electronic device of claim 12, wherein the one or more processors cause the communication device to deliver a paired communication channel disconnect message to another electronic device in communication with the wireless personal area network associated with the vehicle prior to directing the communication device to establish a paired communication channel with the wireless personal area network associated with the vehicle.

17. A method, the comprising:
receiving, with an ultra-wideband component carried by a device coupled to a vehicle, at least two ultra-wideband signals from at least two electronic devices approaching, entering, or in the vehicle;
determining, with one or more processors operable with the ultra-wideband component from one or more characteristics associated with the at least two ultra-wideband signals which electronic device of the at least two electronic devices is approaching, entering, or in a driver's seat of the vehicle; and
directing, by the one or more processors using the ultra-wideband component, the which of the at least two electronic devices is approaching, entering, or in the driver's seat of the vehicle to establish an active communication channel with a wireless personal area network provided by electronic components of the vehicle.

18. The method of claim 17, further comprising also directing, by the one or more processors using the ultra-wideband component, another electronic device of the at least two electronic devices to terminate another active communication channel with the wireless personal area network provided by the electronic components of the vehicle.

19. The method of claim 17, wherein the device is coupled to the vehicle at an off-center location relative to a medial delineation of the vehicle.

20. The method of claim 19, wherein the one or more characteristics associated with the at least two ultra-wideband signals determine which electronic device of the at least two electronic devices is closer to the device.
